(19) United States
(12) Patent Application Publication
(10) Pub. No.: US 2011/0031736 A1
(43) Pub. Date: Feb. 10, 2011

(54) METHOD AND APPARATUS FOR REPURPOSING CONSUMER MATERIALS

(76) Inventor: Christine J. Eichers, Minneapolis, MN (US)

Correspondence Address: Jennifer S. Konieczny, Esq.;Wingspan Law, P.C., 2317 119th Circle NE, Blaine, MN, 55449, US

(21) Appl. No.: 12/851,338

(22) Filed: Aug. 5, 2010

Related U.S. Application Data
(60) Provisional application No. 61/231,338, filed on Aug. 5, 2009.

(51) Int. Cl. B42D 15/00

(52) U.S. Cl. 283/117

(57) ABSTRACT

A method and apparatus for repurposing consumer materials. A user may repurpose an article of consumer material by reusing, recycling and sharing the consumer material with another subsequent user. A user of repurposable consumer material may track the transmission of the consumer materials by using information and resources provided and enterable into a tracking system and the process may be substantially repeated with subsequent users.

### RELATED APPLICATIONS

This application claims priority to U.S. Provisional Application Ser. No. 61/231,338 filed Aug. 5, 2009 entitled “Method and Apparatus for Repurposing Consumer Materials” and is hereby incorporated by reference.

### BACKGROUND OF THE INVENTION

This invention relates to a method and apparatus for repurposing consumer materials.

Recycling and reusing of man-made materials has become an important cultural and societal phenomenon, both in the U.S. and world-wide, as a means for responsibly taking care of the environment. Recycling and reusing of materials takes place in a number of realms, including business and residential realms, and with a number of materials, including industrial building materials, such as cement and metal or consumable personal and business products, such as aluminum soda cans, food cans, paper, plastic bottles and containers, to name a few. In many cases, materials can be processed and reused for either its originally-created purpose or for an entirely new purpose.

There exists a need to continue to develop and expand new types of recyclable or reusable products, in order to continue encouraging the health and sustainability of our local and global environment.

### SUMMARY OF THE INVENTION

One aspect of the present invention is to provide a method for reusing consumer materials.

Another aspect of the present invention is to provide a system of encouraging recipients of reusable consumer materials to forward them on to new recipients.

Yet another aspect of the present invention is to provide a repurposable apparatus to an original user who forwards that apparatus onto another user.

Yet another aspect of the present invention is to provide a method of tracking the transmission of reusable consumer materials from one location to another.

Yet another aspect of the present invention is to provide an apparatus that can be tracked from at least one location to another.

### DETAILED DESCRIPTION OF THE INVENTION

In general, the present invention includes a method and apparatus for repurposing consumer materials. In at least one embodiment of the present invention, the consumer materials may be purchased on-line. In at least one embodiment of the invention, the consumer materials will be physically shipped to an original user of the consumer materials. In at least one embodiment of the present invention, repurposing of consumer materials may include, but is not limited to, reducing the use of consumer materials, recycling or reusing consumer materials or originating use of consumer materials and forwarding such materials onto at least one other user with the intention that that user will recycle or reuse such materials and so on and so forth.

Examples of consumer materials may include, but are not limited to, greeting cards, promotional materials and/or educational materials. Promotional materials may including, but are not limited to, flyers, advertisements, newsletters, fundraising information and resources, that promote an event, a cause or a business, to name a few. Educational materials may include newsletters, fundraising information and resources, articles, memoranda, professional opinions or other works of authorship that are meant to educate others.

Consumer materials may further include both physical and virtual embodiments and thus, may be transmitted physically through mail, shipping or other delivery methods and systems, as are presently known to the general public, or virtually transmitted by any number of virtual portals presently known to the public (or as may become known) or may be known by persons of ordinary skill in the virtual arts, including, but not limited to, handheld-technology devices, the internet, computers, GPS and/or wireless, telecommunications, telematics or other such systems.

At least one embodiment of the present invention includes an apparatus for repurposing consumer materials, which may include, but is not limited to, at least one article of consumer material including at least one housing portion, at least a first source identifying portion and at least a second source identifying portion. An article of consumer material including at least one housing portion may include, but is not limited to, greeting cards, note cards, letters or other correspondence-related materials, papers, magazine, books, journals, opinions (whether professional or personal), educational or promotional materials, newsletters, and the like. In at least one embodiment of the present invention, a housing portion may include an area on an article of consumer material that is substantially ideal to receive, place, position or add a first or second identifying portion, as further described herein.

In at least one embodiment of the present invention, first and second source identifying portions (or source identifying portions generally) may include, but are not limited to, content or materials such as labels, tags, signatures, adhesive stickers, stamps, personal or business addresses, barcodes, alphabetical or numerical references, or any combination thereof, and/or a substantially empty, available or suitable space where content or material regarding an originating source of information may be received, placed or provided by an actual or potential user of consumer material, or other indicators that would provide identified information as to an original source. In at least one embodiment of the present invention, source identifying portions may include devices or materials that permit, allow and/or provide a trackable signal that may be detectable and transmittable through wireless, GPS or other telecommunications or telematics-related devices and systems.

In at least one embodiment of the present invention, a method for repurposing consumer materials may include the steps of: providing at least one first user of consumer material with at least one article of consumer material, said consumer material comprising at least one housing portion and at least one first source identifying portion; providing at least one second source identifying portion to said first user; allowing said first user to place said at least one second source identifying portion at a location on said housing portion such that said at least one first source identifying portion is substantially covered by said at least one second source identifying portion; having said first user transmit said at least one article of consumer material to at least one second user; and having said at least one second user repeat substantially each of the same steps described herein with at least another user. In at least one embodiment of the present invention, a plurality of users could transmit the information and/or consumer materials and further, track the progress of the transmission of the consumer materials via a tracking system, as further described herein.

In at least one embodiment of the present invention, a method for tracking repurposable consumer material may include the steps of: providing at least one first user of consumer material with at least one article of consumer material, said consumer material comprising at least one housing portion and at least one first source identifying portion; providing said at least one source identifying portions comprising information that may be enterable into a tracking system; providing user access to a tracking system; providing instruction regarding use of tracking system; permitting said information to be entered by user in said tracking system; having said first user transmit said at least one article of consumer material to at least one second user; and having said at least one second user repeat substantially each of the same steps described herein with at least another user.

In at least one embodiment of the present invention, the consumer material may be trackable by entering information provided or made available via source identifying portions (as earlier described) or by some other source of information and/or any combination thereof, into a trackable system. In at least one embodiment of the present invention, a trackable system may include a system that is accessible via computers, hand-held devices, GPS systems, computer and other technology-based networks, telecommunications systems (as earlier described herein) and internet-based or related platforms and systems known to the public and by persons of ordinary skill in such arts. In at least one embodiment of the present invention, for example, a user may enter information from a source identifying portion into a computer, through software made available via an internet-based interface, transmit, mail or ship consumer material associated with such information to another user or recipient, encourage that user or recipient to repeat the process, and, subsequently, track the transmission of the consumer material from user to user.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and description herein are proffered by way of example to facilitate comprehension of the invention and should not be construed to limit the scope thereof.

What is claimed is:

1. An apparatus for repurposing consumer material, comprising:
at least one article of consumer material comprising at least one housing portion;
at least a first source identifying portion; and
at least a second source identifying portion
wherein said second source identifying portion substantially covers said first source identifying portion on said at least one article of said consumer material and wherein said at least one article of consumer material is subsequently sent from at least a first user to a second user.

2. The apparatus of claim 1 wherein said at least one article of consumer material comprises a greeting card.

3. The apparatus of claim 1 wherein said housing portion further comprising a pre-affixed, integrated first source identifying portion.

4. The apparatus of claim 3 wherein said pre-affixed, integrated first source indentifying portion comprises a bar code.

5. The apparatus of claim 1 wherein said at least one an article of consumer material comprises material that is promotional in nature.

6. The apparatus of claim 1 wherein said at least one an article of consumer material comprises an electronic greeting card.

7. The apparatus of claim 1 wherein said at least one an article of consumer material comprises an article of consumer material that is trackable.

8. The apparatus of claim 1 wherein said at least a first source identifying portion comprises a greeting and signature.

9. The apparatus of claim 1 wherein said at least a first source identifying portion is removably pre-affixed to said at least one housing portion.

10. The apparatus of claim 1 wherein said at least a first source identifying portion is permanently pre-affixed to said at least one housing portion.

11. The apparatus of claim 1 wherein said at least a second source identifying portion comprises a substantially blank label on which content may be entered.

12. The apparatus of claim 1 wherein said at least a second source identifying portion is removably affixable to said at least one housing portion.

13. The apparatus of claim 1 wherein said at least a second source identifying portion is placable at a location on said at least one housing portion that substantially covers said first source identifying portion.

14. The apparatus of claim 1 wherein said at least a second source identifying portion is permanently affixable to said at least one housing portion that substantially covers said first source identifying portion.

15. Method for repurposing consumer material, comprising the steps of:
providing at least one first user of consumer material with at least one article of consumer material, said consumer material comprising at least one housing portion and at least one first source identifying portion;
providing at least one second source identifying portion to said first user;
allowing said first user to place said at least one second source identifying portion at a location on said housing portion such that said at least one first source identifying portion is substantially covered by said at least one second source identifying portion;
having said first user transmit said at least one article of consumer material to at least one second user; and
having said at least one second user repeat substantially each of the same steps described herein with at least one other user.

16. The method of claim 15 wherein having said at least one second user repeat substantially each of the same steps described herein with at least one other user comprises having said at least one second user repeat substantially each of the same steps described herein with a plurality of subsequent users.

17. The method of claim 15 wherein providing consumer material comprising at least one housing portion and at least one first source identifying portion comprises providing consumer material comprising at least one housing portion and at least one device that is substantially trackable via a GPS-based system.

18. Method for tracking repurposable consumer material, comprising the steps of:
providing at least one first user of consumer material with at least one article of consumer material, said consumer material comprising at least one housing portion and at least one first source identifying portion;
providing said at least one source identifying portions comprising information that may be enterable into a tracking system;
providing user access to a tracking system;
providing instruction regarding use of tracking system;
permitting said information to be entered by user in said tracking system;
having said first user transmit said at least one article of consumer material to at least one second user; and
having said at least one second user repeat substantially each of the same steps described herein with at least another user.

19. The method of claim 18 wherein providing consumer material comprising at least one housing portion and at least one first source identifying portion comprises providing consumer material comprising at least one pre-affixed trackable portion.

20. The method of claim 18 wherein providing user access to a tracking system comprising providing user access to an internet-based system into which tracking information can be entered and thereafter, observed by users and the general public.
